(19) United States
(12) Patent Application Publication
(10) Pub. No.: US 2008/0297410 A1
(43) Pub. Date: Dec. 4, 2008

(54) Satellite receiver detachably combined to blue tooth handset

(76) Inventor: Chii-Moon Liou, Taipei Hsien (TW)

Correspondence Address: CHII-MOON LIOU, 235 Chung-Ho, Box 8-24, Taipei, TW

(21) Appl. No.: 11/809,288

(22) Filed: Jun. 1, 2007

(51) Int. Cl. G01S 1/00; H04B 7/185

(52) U.S. Cl. 342/357.12; 455/3.02

(57) ABSTRACT

A satellite receiver detachably combined to a blue tooth handset comprises a blue tooth satellite receiver module including a blue tooth module, a central processing unit, satellite receiver module, a GPS satellite antenna, and a power control module; the satellite receiver module being coupled to the GPS satellite antenna for receiving signals and then decoding the signals; the decoded signals being transferred to the central processing unit to be processed and then sent digital data to the blue tooth module; a blue tooth handset including a blue tooth module, an auto-dialing transmission software unit, and a mobile phone module; the signals from the blue tooth module being received by the blue tooth module of the handset; then the signals received by the blue tooth module being transferred to the auto-dialing transmission software unit; and then the mobile phone module actuating a dialing mechanism for transferring message to a receiving end.

### FIELD OF THE INVENTION

The present invention relates to blue tooth devices, and particularly to a satellite receiver detachably combined to a blue tooth handset, wherein it is especially used an emergency call and the real timer receiver of a satellite handset. It can be realized easily and can be carried out easily.

### BACKGROUND OF THE INVENTION

Referring to FIG. 1, the prior art GPS handset 10 or GPS/GSM tracking device 11 can trace an object by satellite positioning. Further a positioning address is transmitted to a message control end through a GSM communication network, an Internet, or a conventional communication network, such as PSTN so that the owner of the message control end can know the position of the handset.

However the handset with satellite mobile positioning functions also include functions of such as auto-dialing, geometrical messages, mobile phone modules, etc. Thus the usable power period, volume, and sensors are also confined and thus it has a large size and the operation is installed, while in emergency, the user must dial the handset immediately, but the prior art handset often induces a delay in operation.

### SUMMARY OF THE INVENTION

Accordingly, the primary object of the present invention is to provide a satellite receiver detachably combined to a blue tooth handset, wherein it is especially used for an emergency call and the real timer receiver of a satellite handset. It can be realized easily and can be carried out easily.

In the present invention, by the blue tooth modules in the blue tooth satellite receiver module and a blue tooth handset module, the blue tooth satellite receiver module and a blue tooth handset module can be used individually. Thereby in the coverage of the receiving of a blue tooth module, it has the property of the blue tooth satellite receiver module and blue tooth handset module.

To achieve above objects, the present invention provides a satellite receiver detachably combined to a blue tooth handset comprising: a blue tooth satellite receiver module including a blue tooth module, a central processing unit, satellite receiver module, a GPS satellite antenna, and a power control module; the power control module being provided as a voltage source to supply power to the satellite receiver module, the central processing unit and the blue tooth module; the satellite receiver module being coupled to the GPS satellite antenna for receiving signals from a GPS satellite and then decoding the signals; the decoded signals being transferred to the central processing unit for further processing; then the central processing unit sending digital data to the blue tooth module; then signals from the blue tooth module is transferred out; and a blue tooth handset including a blue tooth module, an auto-dialing transmission software unit, and a mobile phone module; the signals from the blue tooth module being received by the blue tooth module of the blue tooth handset; then the signals received by the blue tooth module being transferred to the auto-dialing transmission software unit for auto-dialing and transferring the dialing number to the mobile phone module; then the mobile phone module actuating a dialing mechanism for transferring message to a receiving end.

The various objects and advantages of the present invention will be more readily understood from the following detailed description when read in conjunction with the appended drawing.

### BRIEF DESCRIPTION OF THE DRAWINGS

FIG. 1 shows the structure of a prior art handset with satellite positioning function.

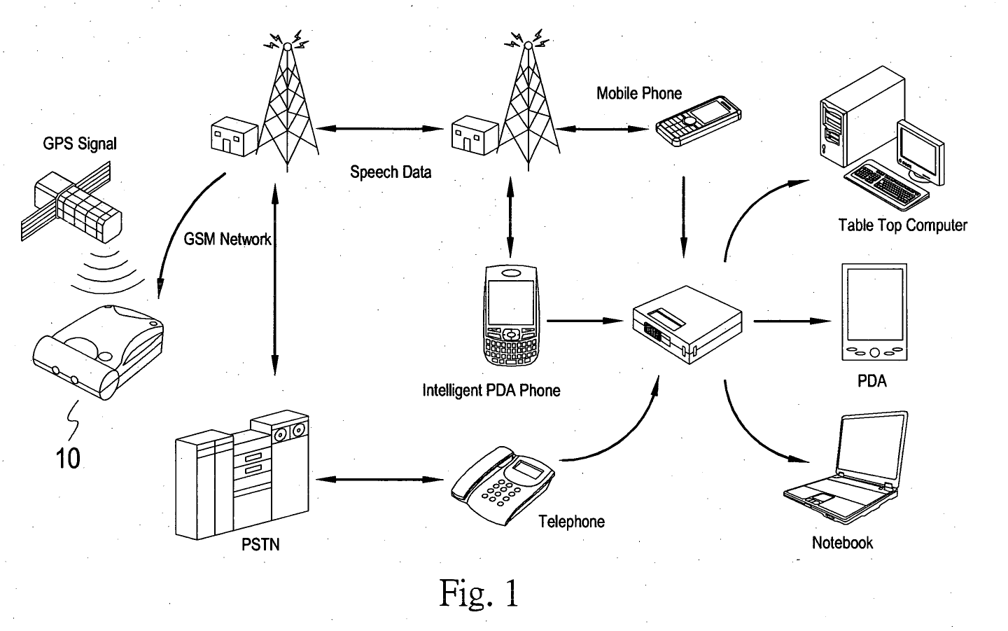

FIG. 2 shows the structure about the main components of the satellite receiver of the present invention.

FIG. 3 is a schematic view showing the use of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

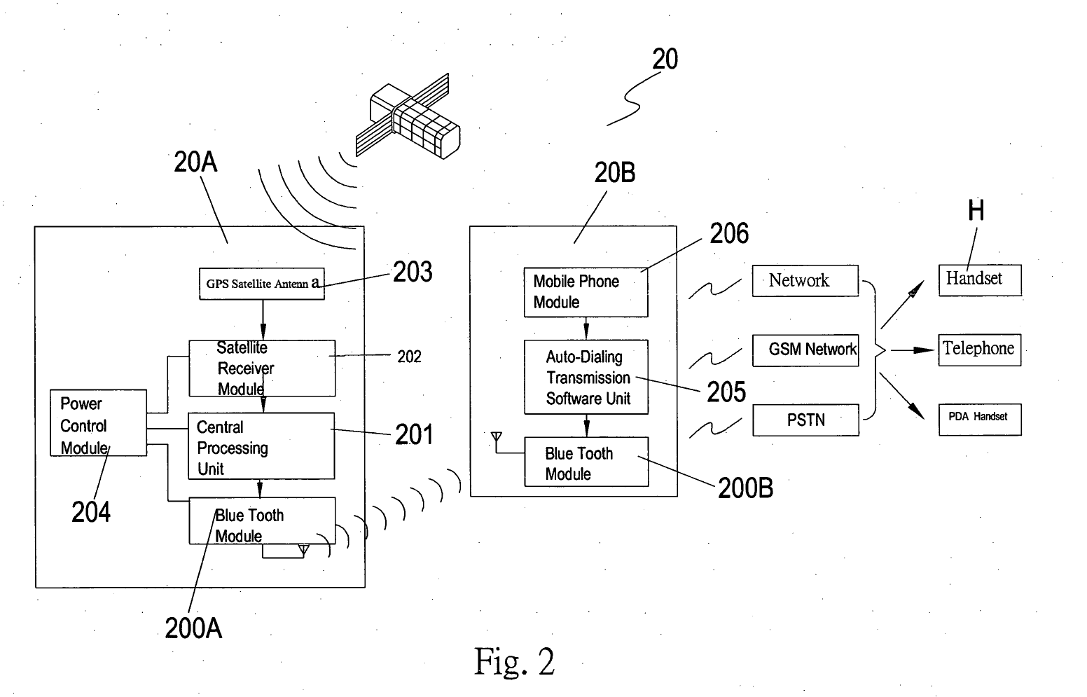

Referring to FIG. 2, the satellite receiver 20 detachably combined to a blue tooth handset of the present invention is illustrated.

A blue tooth satellite receiver module 20A includes a blue tooth module 200A, a central processing unit 201, satellite receiver module 202, a GPS satellite antenna 203, and a power control module 204. The power control module 204 is provided as a voltage source to supply power to the satellite receiver module 202, central processing unit 201 and blue tooth module 200A. The satellite receiver module 202 is coupled to the GPS satellite antenna 203 for receiving signals from a GPS satellite and then decoding the signals. The decoded signals are transferred to the central processing unit 201 for further processing. Then the central processing unit 201 sends digital data to the blue tooth module 200A. Then signals from the blue tooth module 200A is transferred out.

A blue tooth handset 20B includes a blue tooth module 200B, an auto-dialing transmission software unit 205, and a mobile phone module 206. The signals from the blue tooth module 200A is received by the blue tooth module 200B of the blue tooth handset 20B. Then the signals received by the blue tooth module 200B is transferred to the auto-dialing transmission software unit 205 for auto-dialing and transferring the dialing number to the mobile phone module 206. Then the mobile phone module 206 actuates a dialing mechanism for transferring message to a receiving end.

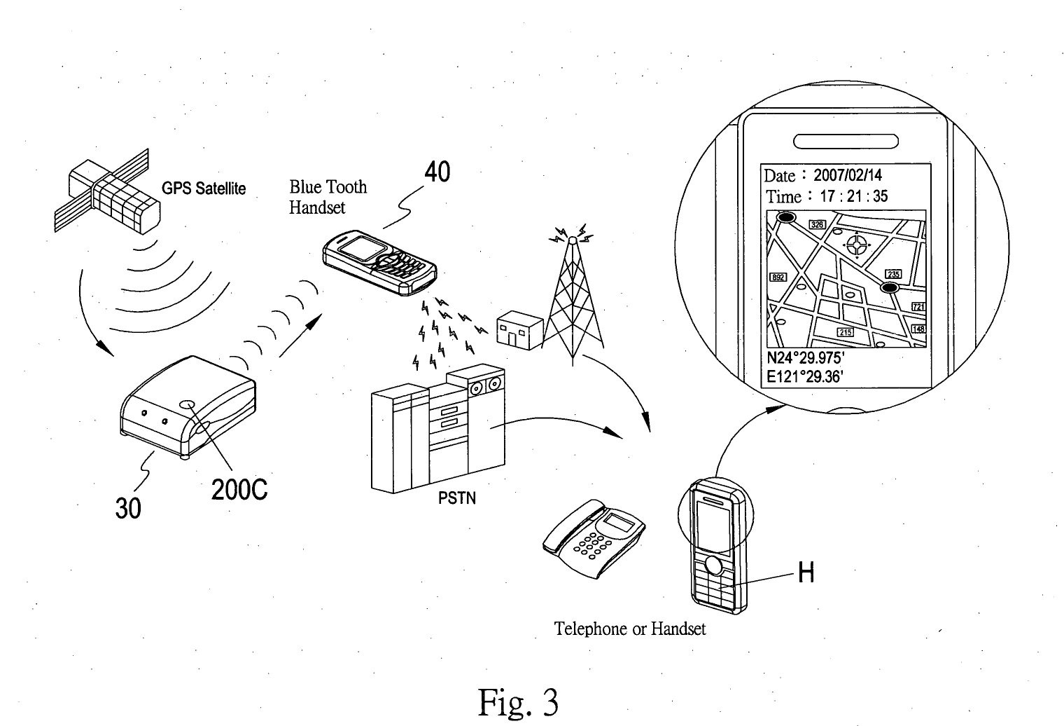

Referring to FIG. 3, a schematic view about the application of the present invention is illustrated. A blue tooth satellite receiver 30 has a size approximately equal to that of a [symbol] box. A lateral side of the blue tooth satellite receiver 30 is installed with at least one mechanism control button 200C which may be triggered by mobile reactions, such as emergency calls, landmark positioning, tracking and tracing, responses of [symbol] , etc). By the blue tooth module 200A in the blue tooth satellite receiver 30B, the digital data from the blue tooth module 200A is wirelessly transferred to another blue tooth satellite receiver. By the auto-dialing mechanism of the another blue tooth satellite receiver, the mobile reaction trigger message from the mechanism control button 200C of the blue tooth satellite receiver 30 is transferred to a receiving end for displaying or sounding. Therefore, the object of far-end calling or mobile communication is achieved. In this embodiment, the receiver is a blue tooth handset 40 which is built in with a plurality of auto-dialing transmission software unit 205 which is triggered by the reaction from the mechanism control button 200C so as to transfer the signals to at least one handset H as a receiving end and display messages thereon.

Advantages of the present invention are that the present invention has a smaller volumes, and can be portable easily and conveniently. By the widely used mobile phone with blue tooth module, it is unnecessary to buy another mobile phone. The button has a simple structure and in emergency, it is unnecessary to find another handset. The blue tooth satellite receiver and the blue tooth mobile phone can be used individually.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A satellite receiver detachably combined to a blue tooth handset comprising:
a blue tooth satellite receiver module including a blue tooth module, a central processing unit, satellite receiver module, a GPS satellite antenna, and a power control module; the power control module being provided as a voltage source to supply power to the satellite receiver module, the central processing unit and the blue tooth module; the satellite receiver module being coupled to the GPS satellite antenna for receiving signals from a GPS satellite and then decoding the signals; the decoded signals being transferred to the central processing unit for further processing; then the central processing unit sending digital data to the blue tooth module; then signals from the blue tooth module is transferred out;
a blue tooth handset including a blue tooth module, an auto-dialing transmission software unit, and a mobile phone module; the signals from the blue tooth module being received by the blue tooth module of the blue tooth handset; then the signals received by the blue tooth module being transferred to the auto-dialing transmission software unit for auto-dialing and transferring the dialing number to the mobile phone module; then the mobile phone module actuating a dialing mechanism for transferring message to a receiving end.

2. The satellite receiver detachably combined to a blue tooth handset as claimed in claim 1, wherein the blue tooth satellite receiver is installed with at least one mechanism control button which is triggered by mobile reactions.

3. The satellite receiver detachably combined to a blue tooth handset as claimed in claim 1, wherein the mobile reaction is one of emergency calls, landmark positioning, tracking and tracing, responses of [symbol] .

4. The satellite receiver detachably combined to a blue tooth handset as claimed in claim 1, wherein the receiver is a blue tooth handset which is built in with a plurality of auto-dialing transmission software unit which is triggered by the reaction from the mechanism control button so as to transfer the signals to at least one handset as a receiving end and display messages thereon.
